(19) United States
(12) Patent Application Publication
(10) Pub. No.: US 2025/0232765 A1
(43) Pub. Date: Jul. 17, 2025

(54) TEST-TIME ADAPTATION FOR AUTOMATIC SPEECH RECOGNITION VIA SEQUENTIAL-LEVEL GENERALIZED ENTROPY MINIMIZATION

(71) Applicant: Korea Advanced Institute of Science and Technology, Daejeon (KR)

(72) Inventors: Eunho YANG, Daejeon (KR); Changhun KIM, Daejeon (KR); Joonhyung PARK, Daejeon (KR); Hajin SHIM, Daejeon (KR)

(21) Appl. No.: 18/594,442

(22) Filed: Mar. 4, 2024

(30) Foreign Application Priority Data
Jan. 16, 2024 (KR) 10-2024-0006413
Feb. 19, 2024 (KR) 10-2024-0023266

(51) Int. Cl. G10L 15/183; G10L 15/06; G10L 15/08

(52) U.S. Cl. CPC G10L 15/183; G10L 15/063; G10L 2015/088

(57) ABSTRACT

Disclosed is test-time adaptation technology for a speech recognition model through sequential level-generalized entropy minimization that may include acquiring a logit based on a beam search for a single utterance in a target domain; and adjusting parameters of the speech recognition model by performing entropy minimization and negative sampling using the acquired logit.

### CROSS-REFERENCE TO RELATED APPLICATION(S)

This application claims the priority benefit of Korean Patent Application No. 10-2024-0006413, filed on Jan. 16, 2024, 10-2024-0023266, filed on Feb. 19, 2024, in the Korean Intellectual Property Office, the disclosure of which is incorporated herein by reference.

### BACKGROUND

### 1. Field of the Invention

Example embodiments relate to test-time adaptation technology for a speech recognition model.

### 2. Description of the Related Art

Automatic speech recognition (ASR) models are frequently exposed to data distribution shifts in many real-world scenarios, leading to erroneous prediction. To tackle this issue, a test-time adaptation (TTA) method has recently been proposed to adapt a pre-trained automatic speech recognition model on unlabeled test instances without source data. Despite improvement in performance, the test-time adaptation method relies solely on naïve greedy decoding and performs adaptation across timesteps at a frame level, which may not be optimal given the sequential nature of model output.

### SUMMARY

Example embodiments are to adjust parameters of a speech recognition model by acquiring a logit based on beam search for a single utterance in a target domain and by performing entropy minimization and negative sampling using the acquired logit.

According to an aspect, there is provided a test-time adaptation method for a speech recognition model performed by a computer system, the test-time adaptation method including acquiring a logit based on a beam search for a single utterance in a target domain; and adjusting parameters of the speech recognition model by performing entropy minimization and negative sampling using the acquired logit.

The speech recognition model may be pre-trained in a source domain that includes a pair of labeled speech data and text data.

The acquiring may include setting a test-time adaptation (TTA) for the speech recognition model, and the test-time adaptation may adapt the speech recognition model to an unlabeled target domain without access to a source domain.

The acquiring may include receiving a single utterance for the target domain as input and outputting a logit of each vocabulary for each timestep to the speech recognition model.

The acquiring may include searching for a most probable output sequence that approximates optimal output of the speech recognition model based on beam search decoding.

The adjusting may include performing Rényi entropy minimization to reduce Rényi entropy of the speech recognition model using the acquired logit.

The adjusting may include considering, as a negative class, a class with a probability less than a threshold in each timestep using the acquired logit and performing negative sampling to reduce the probability of the considered negative class.

An unsupervised objective function of the speech recognition model may be derived through a weighted sum of entropy minimization loss and negative sampling loss.

According to an aspect, there is provided a non-transitory computer-readable recording medium storing instructions that, when executed by a processor, cause the processor to perform a test-time adaptation method for a speech recognition model performed by a computer system, the test-time adaptation method including acquiring a logit based on a beam search for a single utterance in a target domain; and adjusting parameters of the speech recognition model by performing entropy minimization and negative sampling using the acquired logit.

According to an aspect, there is provided a computer system including a memory; and a processor configured to connect to the memory and to execute at least one instruction stored in the memory. The processor is configured to acquire a logit based on a beam search for a single utterance in a target domain, and to adjust parameters of the speech recognition model by performing entropy minimization and negative sampling using the acquired logit.

According to some example embodiments, it is possible to improve performance of a speech recognition model in various domain shifts through test-time adaptation for the speech recognition model.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a test-time adaptation operation for a speech recognition model according to an example embodiment;

FIG. 2 is a flowchart illustrating a test-time adaptation method for a speech recognition model according to an example embodiment;

FIG. 3 is a diagram illustrating a computer system according to an example embodiment; and

FIG. 4 is a graph showing comparison of test-time adaptation performance.

### DETAILED DESCRIPTION

Hereinafter, example embodiments will be described with reference to the accompanying drawings.

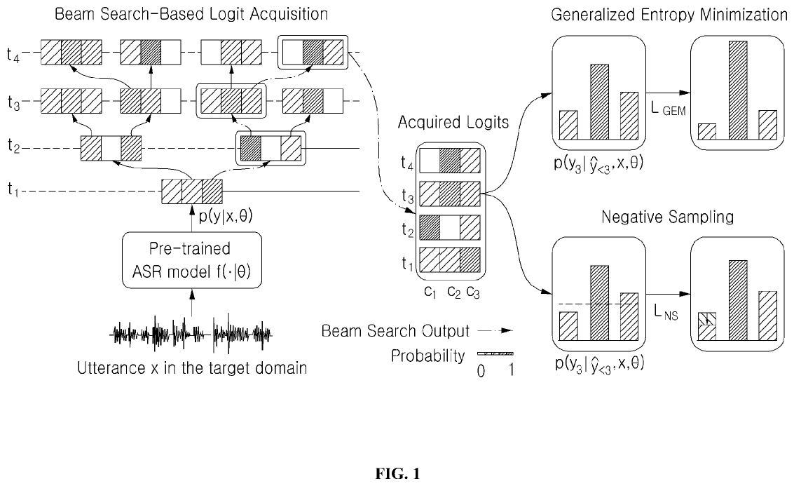

FIG. 1 illustrates a test-time adaptation operation for a speech recognition model according to an example embodiment.

A computer system may set up test-time adaptation for a speech recognition model. Let f(·|θ) be a speech recognition model trained in a labeled source domain [symbol] ₛ={(xᵢ^{s}, yᵢ^{s})}ᵢ that includes pairs of speech and text. The speech recognition model receives speech (utterance) x as input and outputs a logit (log probability) of each vocabulary f(x|θ)∈ [symbol] for each timestep. Here, L denotes the number of timesteps, C denotes the number of vocabulary classes, and θ denotes a parameter of the speech recognition model. The speech recognition model models a lob joint probability log p(y|x, θ) of candidate text speech recognition model models a log joint probability y=[y₁, . . . y_{L}] as in Equation 1:

$$log p ( y \vert x , θ ) := log {p}_{AM} ( y \vert x , θ ) + {λ}_{LM} log {p}_{LM} ( y ) + Z = {\sum }_{i = 1}^{L} log {p}_{AM} ( {y}_{i} \vert {y}_{< i} , x , θ ) + {λ}_{LM} log {p}_{LM} ( {y}_{i} \vert {y}_{< i} ) + Z \qquad Equation 1$$

In Equation 1, y₁∈{1, . . . , C}, PAM (y|x, θ) denotes a joint probability given by model output f(x|θ), p_{LM}(y) denotes a joint probability of an autoregressive language model, λ_{LM} denotes a hyperparameter to control the effect of a language model, and Z denotes a normalizing constant. A decoding method of the speech recognition model approximates Equation 2 that is an optimal solution.

$${y}^{*} = {arg max}_{y} log p ( y \vert x , θ ) \qquad Equation 2$$

A test-time adaptation method for a speech recognition model f(·|θ) aims to adapt the model to an unlabeled target speech domain [symbol] ₜ={xᵢ^{t}}ᵢ without access to the source domain [symbol] ₛ. Specifically, the computer system considers a single-utterance test-time adaptation setting, aiming to fine-tune parameter θ of the speech recognition model f(·|θ) for each utterance xᵢ^{t}∈ [symbol] ₜ to acquire a more precise output logit log p(y|xᵢ^{t}, θ) with unsupervised objective function using only xᵢ^{t}. This single-utterance test-time adaptation setting is considerably pragmatic in that it is available without assuming that test instances are independent and identically distributed and an adaptation time is less consumed.

The computer system may acquire a logit based on beam search. The existing test-time adaptation method for the speech recognition model exploits a greedy decoding strategy without using an external language model (i.e., λ_{LM}=0) to acquire an output logit. However, naively using greedy decoding increases a probability of outputting wrong labels and may mislead the model to be adapted on the wrong labels. Also, this frame-level adaptation using greedy decoding may not be optimal on a sequential level that is the entire output of the speech recognition model since independent adaptation is performed for each timestep without considering the entre output context.

Therefore, the computer system exploits a more accurate output logit acquisition strategy based on beam search decoding. Specifically, given a beam width B, most probable output sequence ŷ=[ŷ₁, . . . , ŷ_{L}] that approximates y* of Equation 2 using beam search is found. In this state, logits of beam candidates are not held to reduce memory consumption. Instead, estimated sequence ŷ is passed to the model again to acquire an i-th logit oᵢ=log p(ŷᵢ=j|ŷ_{<x}, θ)∈ [symbol] for all i∈{1, . . . , L}. Through beam search-based logit acquisition, more accurate logit than greedy decoding may be acquired while matching the actual sentence generated by the speech recognition model.

The computer system may perform generalized entropy minimization. Entropy minimization is proven to improve performance to some extents in test-time adaptation by reducing uncertainty of prediction and by extracting domain-invariant features in a target domain. To further improve this entropy minimization method, the example embodiment proposes minimization of Rényi entropy that is a generalized version of existing Shannon entropy. For a discrete random variable X having a value between 1 and C, Rényi entropy H_{α}(X) of order α∈(0, 1)∪(1, ∞) is defined as Equation 3.

$${H}_{α} ( X ) = \frac{1}{1 - α} log ( {\sum }_{j = 1}^{C} {P ( X = j )}^{α} ) \qquad Equation 3$$

In Equation 3, when α→1 and α→∞, H_{α}(x) becomes Shannon entropy and cross-entropy with a pseudo-label

$${arg max P}_{j} ( X = j ) ,$$

respectively. For the single-utterance test-time adaptation setting, it is assumed that an optima value of α∈(1, ∞) is present and a generalized entropy minimization objective function [symbol] _{GEM} is defined as Equation 4.

$${ℒ}_{GEM} = \frac{1}{L} {\sum }_{i = 1}^{L} \frac{1}{1 - α} log ( {\sum }_{j = 1}^{1} {p}_{ij}^{α} ) \qquad Equation 4$$

In Equation 4,

$${p}_{ij} = \frac{exp ( {o}_{ij} / T )}{{\sum }_{{j}^{′} = 1}^{C} exp ( {o}_{{ij}^{′}} / T )}$$

and T denotes a hyperparameter for preventing vanishing gradient. A timestep with a highest probability of blank token is not used for objective function calculation to alleviate a class imbalance problem.

The computer system may perform negative sampling. In addition to the generalized entropy minimization, the example embodiment exploits negative sampling. Negative sampling refers to an objective function of further reducing a probability of a class with a low probability and it is known that semi-supervised learning adds negative sampling and it may further improve performance of existing semi-supervised learning algorithm. Negative sampling may be derived from standard cross-entropy. Given L labeled samples {(xᵢ, yᵢ) [symbol] , standard cross-entropy loss [symbol] _{CE} is defined as Equation 5.

$${ℒ}_{C B} = - \frac{1}{L} {\sum }_{i = 1}^{L} {\sum }_{j = 1}^{C} {[ j = {y}_{i} ]}_{} log {p}_{ij} \qquad Equation 5$$

In Equation 5, Σⱼ₌₁^{C} [symbol] _{[j=y}_{ᵢ}_{]} log pᵢⱼ=log(1−Σ_{j≠y}_{ᵢ}pᵢⱼ). In the case of a target domain without a label, when applying the same to an unlabeled target domain, ground truth label yᵢ for each xᵢ is not known, so [symbol] _{CE} is approximated to [symbol] _{NS} as shown in Equation 6.

$${ℒ}_{NS} = - \frac{1}{L} {\sum }_{i = 1}^{L} log ( 1 - {\sum }_{j = 1}^{C} {[ {p}_{ij}^{′} < τ ]}_{} {p}_{ij} ) \qquad Equation 6$$

In Equation 6,

$${p}_{ij} = \frac{exp ( {o}_{ij} / T )}{{\sum }_{{j}^{′} = 1}^{C} exp ( {o}_{{ij}^{′}} / T )} , {p}_{ij}^{′} = \frac{exp ( {o}_{ij} )}{{\sum }_{{j}^{′} = 1}^{C} exp ( {o}_{{ij}^{′}} )} ,$$

T denotes a hyperparameter for preventing vanishing gradient, and [symbol] denotes an indicator function. A j-th class of xᵢ is considered as a negative class when a probability pᵢⱼ for the j-th class is less than a threshold τ. Without modification, Equation 6 may be interpreted in a single-utterance test-time adaptation setting as an objective function of further reducing a probability of a negative class at every timestep for sequential output with length L.

A final unsupervised objective function proposed herein is a weighted sum of generalized entropy minimization and negative sampling and defined as Equation 7.

$$ℒ = {ℒ}_{GEM} + {λ}_{NS} {ℒ}_{NS} \qquad Equation 7$$

In Equation 7, λ_{NS} denotes a negative sampling weight for balancing two loss functions. For each utterance, the model is newly reset to a pre-trained model for a source domain and is adapted for N iterations.

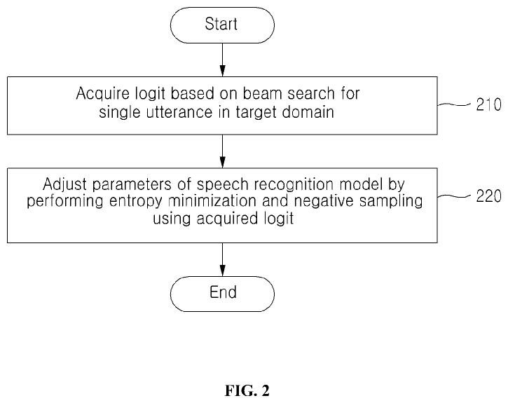

FIG. 2 is a flowchart illustrating a test-time adaptation method for a speech recognition model according to an example embodiment.

In operation 210, a computer system may acquire a logit based on beam search for a single utterance in a target domain. The computer system may set test-time adaptation for the speech recognition model. Here, the test-time adaptation represents adapting the speech recognition model to the unlabeled target domain without access to a source domain. The computer system may receive a single utterance for the target domain as input and may output a logit of each vocabulary for each timestep to the speech recognition model. The computer system may search for a most probable output sequence that approximates optimal output of the speech recognition model based on beam search decoding. That is, the computer system may acquire the estimated output sequence and then may acquire a logit of each timestep by delivering the acquired output sequence again to the speech recognition model.

In operation 220, the computer system may adjust parameters of the speech recognition model by performing entropy minimization and negative sampling using the acquired logit. Here, the speech recognition model may be pre-trained in a source domain that includes a pair of labeled speech data and text data. The computer system may perform Rényi entropy minimization using the acquired logit to reduce Rényi entropy of the speech recognition model. The computer system may consider, as a negative class, a class with a probability less than a threshold in each timestep using the acquired logit and may perform negative sampling to reduce the probability of the considered negative class. The computer system may derive an unsupervised objective function of the speech recognition model through a weighted sum of entropy minimization loss and negative sampling loss.

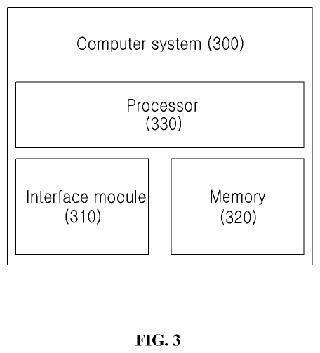

FIG. 3 is a diagram illustrating a computer system according to an example embodiment.

A computer system 300 may include at least one of an interface module 310, a memory 320, and a processor 330. In some example embodiments, at least one of components of the computer system 300 may be omitted and at least one another component may be added. In some example embodiments, at least two components among the components of the computer system 300 may be implemented as a single integrated circuit.

The interface module 310 may provide an interface for the computer system 300. According to an example embodiment, the interface module 310 may include a communication module and the communication module may communicate with an external device. The communication module may establish a communication channel between the computer system 300 and the external device and may communicate with the external device through the communication channel. The communication module may include at least one of a wired communication module and a wireless communication module. The wired communication module may be connected to the external device in a wired manner and may communicate with the external device in the wired manner. The wireless communication module may include at least one of a near-field communication module and a far-field communication module. The near-field communication module may communicate with the external device using a near-field communication method. The far-field communication module may communicate with the external device using a far-field communication method. Here, the far-field communication module may communicate with the external device through a wireless network. According to another example embodiment, the interface module 310 may include at least one of an input module and an output module. The input module may input a signal to be used for at least one component of the computer system 300. The input module may include at least one of an input device configured to allow a user to directly input a signal to the computer system 300, a sensor device configured to detect a surrounding environment and to generate a signal, and a camera module configured to capture a video and to generate video data. The output module may include at least one of a display module configured to visually display information and an audio module configured to output information as an audio signal.

The memory 320 may store a variety of data used by at least one component of the computer system 300. For example, the memory 320 may include at least one of a volatile memory and a non-volatile memory. Data may include at least one program and input data or output data related thereto. A program may be stored in the memory 320 as software that includes at least one instruction.

The processor 330 may control at least one component of the computer system 300 by executing the program of the memory 320. Through this, the processor 330 may perform data processing or operation. Here, the processor 330 may execute an instruction stored in the memory 320.

The processor 330 may adjust parameters of a speech recognition model by acquiring a logit based on beam search for single utterance in a target domain and by performing entropy minimization and negative sampling using the acquired logit.

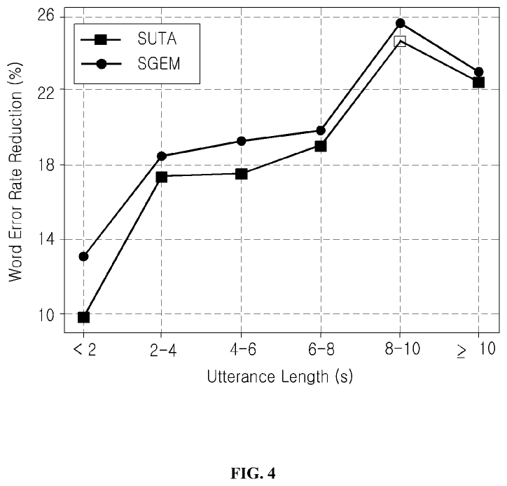

FIG. 4 is a graph showing comparison of test-time adaptation performance according to an example embodiment.

Various experiments may be performed to verify performance of a method proposed in an example embodiment. Through comprehensive experiments, the method (sequential-level generalized entropy minimization (SGEM)) proposed in the example embodiment achieves excellent performance for three mainstream speech recognition models and shows robustness to a distribution change in various datasets. This includes a wide range of real-world scenarios, such as speakers or words not exposed during training, corpora with high background noise, non-native English speech with clear pronunciation difference, data deficient condition, and low signal-to-noise ratio (SNR). In addition, removal experiments may be performed to evaluate the effect of each component of the proposed method (SGEM).

### Source Automatic Speech Recognition Model

To verify the efficacy of the proposed method (SGEM), the SGEM may be evaluated on three mainstream automatic speech recognition (ASR) architectures, a CTC-based model, Conformer, and Transducer. In detail, for the CTC-based model, wav2vec 2.0 trained on a LibriSpeech dataset is used. For Conformer, Conformer-CTC trained on the LibriSpeech dataset is used. For Transducer, Conformer-Transducer trained on a composite NeMO ASRSET dataset, including the LibriSpeech dataset, is adopted. An external 4-gram language model is used for the CTC-based model and Conformer.

### Datasets

The performance of the proposed method (sequential-level generalized entropy minimization (SGEM)) may be evaluated under various domain shift settings. To test the proposed method (SGEM) under unseen speakers/words, a test set of four datasets, CHIME-3 (CH), TED-LIUM 2 (TD), Common Voice (CV), and Valentini (VA), are used. Also, the proposed method (SGEM) is validated under accident background noise by injecting the following eight types of background noise to each utterance of in-domain LibriSpeech test-other dataset, that is, air conditioner (AC) noise, airport announcement (AA) noise, babble (BA) noise, copy machine (CM) noise, munching (MU) noise, neighbor (NB) noise, shutting door (SD) noise, and typing (TP) noise with SNR=10 dB. For each type of noise, a single noise sample is randomly selected from an MS-SNSD noise test set. Also, the proposed method (SGEM) is evaluated on L2-Arctic, non-native English speech corpora, to verify the proposed method (SGEM) under extreme pronunciation/accent shifts. In detail, a single speaker is randomly selected for each first language.

### Implementation Details

Since a test-time adaptation setting has no validation set, hyperparameters are optimized on a CH dataset for each model and applied to other datasets. The optimal settings are as follows. For all models, AdamW optimizer and cosine annealing learning rate scheduler are used with ηᵢ and η_{f} for initial and final learning rates, respectively, and (N, T, τ)=(10, 2.5, 0.4/C) is set with vocabulary size C. Only a feature extractor is trained for the CTC-based model and only an encoder is trained for other models. Also, (ηᵢ, η_{f}, B, λLM, α, λNS)=(4·10⁻⁵, 2·10⁻⁵, 5, 0.3, 1.5, 1) is set for the CTC-based model, (4·10⁻⁵, 2·10⁻⁵, 5, 0.3, 1.25, 2) is set for Conformer, and (4·10⁻⁶, 2·10⁻⁶, 3, 0, 1.25, 0.5) is set for Transducer. All experiments are performed on Nvidia TITAN Xp and GeForce RTX 3090. Adaptation takes about 0.771 seconds for a 1-second utterance average over three models.

### Main Results

The test-time adaptation performance of three mainstream ASR models, including the CTC-based model, Conformer, and Transducer, across 12 datasets with various domain shifts, is compared. Table 1 presents a word error rate (WER) of automatic speech recognition (ASR) model output generated by a greedy search decoding method, following an evaluation protocol used in a previous study. Additionally, Table 2 shows the test-time adaptation performance for the CTC-based model using beam search decoding with an external language model. For both decoding methods, the automatic speech recognition models using the proposed method (SGEM) consistently enhance the recognition accuracy of target utterances with an average word error rate reduction of 15.6%, except for two cases on NB in which the performance without adaptation is best when using beam search decoding. In addition, the proposed method (SGEM) outperforms the conventional method (SUTA) in terms of the average word error rate (WER) across all 12 datasets for each of three model architectures (CTC-based model: (greedy) 34.1%→33.4%, (beam search) 32.9%→32.4%/Conformer: 39.3%→38.4%/Transducer: 20.8%→20.6%). This indicates superiority of the proposed unsupervised objective and logit acquisition method for adapting sequential language output regardless of a decoding strategy.

TABLE 1

| | Dataset | CH | TD | CV | VA | AC | AA | BA | CM | MU | NB | SD | TP | Avg. |
|---|---|---|---|---|---|---|---|---|---|---|---|---|---|---|
| CTC-based | Unadapted | 31.2 | 13.2 | 36.9 | 14.5 | 28.1 | 40.9 | 66.6 | 49.8 | 50.4 | 119.2 | 19.2 | 26.2 | 41.4 |
| model | SUTA | 25.0 | 12.0 | 31.4 | 11.8 | 17.7 | 31.3 | 55.2 | 39.4 | 39.7 | 113.0 | 15.0 | 17.8 | 34.3 |
| | SGEM | 24.7 | 12.0 | 31.1 | 11.6 | 17.3 | 30.7 | 53.1 | 38.5 | 38.6 | 110.5 | 14.8 | 17.5 | 33.4 |
| Conformer | Unadapted | 28.7 | 15.1 | 36.8 | 17.4 | 18.8 | 44.8 | 74.3 | 45.7 | 56.0 | 122.1 | 20.8 | 36.9 | 43.1 |
| | SUTA | 25.2 | 13.4 | 32.4 | 14.7 | 14.5 | 39.8 | 73.3 | 38.4 | 48.7 | 125.5 | 16.4 | 28.8 | 39.3 |
| | SGEM | 24.5 | 13.3 | 31.6 | 14.6 | 14.4 | 38.5 | 70.4 | 38.7 | 48.5 | 120.9 | 16.8 | 28.9 | 38.4 |
| Transducer | Unadapted | 11.8 | 7.2 | 12.9 | 6.5 | 14.1 | 20.4 | 31.0 | 29.7 | 31.3 | 74.6 | 12.7 | 16.2 | 22.4 |
| | SUTA | 10.3 | 6.8 | 12.1 | 5.6 | 12.0 | 18.5 | 28.3 | 26.7 | 28.7 | 74.6 | 11.7 | 14.7 | 20.8 |
| | SGEM | 9.9 | 6.6 | 12.0 | 5.2 | 11.6 | 18.0 | 27.5 | 26.0 | 28.0 | 76.5 | 11.5 | 14.3 | 20.6 |

TABLE 2

| Dataset | CH | TD | CV | VA | AC | AA | BA | CM | MU | NB | SD | TP | Avg. |
|---|---|---|---|---|---|---|---|---|---|---|---|---|---|
| Unadapted | 29.5 | 12.2 | 36.9 | 13.0 | 26.1 | 38.6 | 58.9 | 48.9 | 49.0 | 91.6 | 17.4 | 23.7 | 37.2 |
| SUTA | 24.1 | 11.6 | 31.5 | 11.4 | 16.8 | 30.3 | 53.2 | 38.1 | 38.6 | 107.9 | 14.1 | 16.9 | 32.9 |
| SGEM | 24.1 | 11.7 | 31.1 | 11.1 | 16.5 | 29.8 | 51.6 | 37.7 | 37.7 | 106.7 | 14.0 | 16.9 | 32.4 |

### Non-Native English Speech Corpora

To show the usability of the proposed method (SGEM) at various domain shifts, the proposed method (SGEM) is further analyzed on six different non-native English speech corpora, which is not American English. The results are summarized in Table 3.

TABLE 3

| Setting | Unadapted | SUTA | SGEM |
|---|---|---|---|
| Arabic | 32.5 | 27.1 | 26.5 |
| Mandarin | 28.5 | 23.3 | 23.1 |
| Hindi | 15.7 | 12.5 | 12.3 |
| Korean | 23.3 | 19.7 | 19.5 |
| Spanish | 35.7 | 29.8 | 29.3 |
| Vietnamese | 18.5 | 15.7 | 15.4 |
| Average | 25.7 | 21.4 | 21.0 |

As shown in Table 3, the proposed method (SGEM) achieves the best results for all corpora, outperforming the baseline. This implies the adaptability of the proposed method (SGEM) under extreme pronunciation/accent shifts, demonstrating its versatility in practical situations with severe speaker shifts, such as globally used online automatic speech recognition systems.

### Data Deficient Condition

It is commonly known that the test-time adaptation method fails under the data deficient condition in which the number of test instances is limited. This still holds in the single-utterance test-time adaptation setting for the automatic speech recognition model in which the utterance length is short, so the number of output tokens is insufficient. To validate the proposed method (SGEM) under this harsh condition, a CH dataset is split according to the utterance length and the proposed method (SGEM) is evaluated with the CTC-based model on each split. As shown in FIG. 4, the proposed method exhibits the best performance in every length interval. Also, it is worth noting that the proposed method (SGEM) significantly outperforms the baseline for extremely short utterances of less than 2 seconds, showing the superiority of the proposed method in a real situation in which short utterances are prevalent and negligible latency is required.

### Ablation Study

To validate core components of the proposed method (SGEM), that is, beam search-based logit acquisition (BS), generalized entropy minimization (GEM), and negative sampling (NS), the ablation study is conducted for three mainstream automatic speech recognition models on CH dataset. As shown in Table 4, both generalized entropy minimization and negative sampling achieve remarkable performance for every model, indicating the efficacy of each component.

TABLE 4

| BS | GEM | NS | CTC | Conformer | Transducer |
|---|---|---|---|---|---|
| X | X | X | 31.2 | 28.7 | 11.8 |
| X | ✓ | X | 24.9 | 24.7 | 10.0 |
| X | X | ✓ | 25.2 | 25.0 | 10.1 |
| X | ✓ | ✓ | 24.8 | 24.7 | 10.0 |
| ✓ | X | ✓ | 24.8 | 24.7 | 10.1 |
| ✓ | ✓ | ✓ | 24.7 | 24.5 | 9.9 |

Meanwhile, even with a small beam size, consistent performance improvement is achieved by substituting greedy search for beam search (for all models) and without using an external language model (for Transducer). This demonstrates effective performance of beam search-based logit acquisition and also suggests that further performance improvement may be expected by using a larger beam size or language model if resources allow.

The apparatuses described herein may be implemented using hardware components, software components, and/or combination of the hardware components and the software components. For example, a processing device and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or at least one combination thereof, for independently or collectively instructing or configuring the processing device to operate as desired. Software and/or data may be embodied in any type of machine, component, physical equipment, virtual equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to example embodiments may be implemented in a form of a program instruction executable through various computer methods and recorded in non-transitory computer-readable media. The media may include, alone or in combination with program instructions, a data file, a data structure, and the like. The program instructions recorded in the media may be specially designed and configured for the example embodiments or may be known to those skilled in the computer software art and thereby available. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of program instructions include a machine code as produced by a compiler and an advanced language code executable by a computer using an interpreter.

Although the example embodiments are described with reference to some specific example embodiments and accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A test-time adaptation method for a speech recognition model performed by a computer system, the test-time adaptation method comprising:
acquiring a logit based on a beam search for a single utterance in a target domain; and
adjusting parameters of the speech recognition model by performing entropy minimization and negative sampling using the acquired logit.

2. The test-time adaptation method of claim 1, wherein the speech recognition model is pre-trained in a source domain that includes a pair of labeled speech data and text data.

3. The test-time adaptation method of claim 2, wherein the acquiring comprises setting test-time adaptation (TTA) for the speech recognition model, and
the test-time adaptation adapts the speech recognition model to an unlabeled target domain without access to a source domain.

4. The test-time adaptation method of claim 3, wherein the acquiring comprises receiving a single utterance for the target domain as input and outputting a logit of each vocabulary for each timestep to the speech recognition model.

5. The test-time adaptation method of claim 4, wherein the acquiring comprises searching for a most probable output sequence that approximates optimal output of the speech recognition model based on beam search decoding.

6. The test-time adaptation method of claim 1, wherein the adjusting comprises performing Rényi entropy minimization to reduce Rényi entropy of the speech recognition model using the acquired logit.

7. The test-time adaptation method of claim 1, wherein the adjusting comprises considering, as a negative class, a class with a probability less than a threshold in each timestep using the acquired logit and performing negative sampling to reduce the probability of the considered negative class.

8. The test-time adaptation method of claim 1, wherein an unsupervised objective function of the speech recognition model is derived through a weighted sum of entropy minimization loss and negative sampling loss.

9. A non-transitory computer-readable recording medium storing instructions that, when executed by a processor, cause the processor to perform a test-time adaptation method for a speech recognition model performed by a computer system, the test-time adaptation method comprising:
acquiring a logit based on a beam search for a single utterance in a target domain; and
adjusting parameters of the speech recognition model by performing entropy minimization and negative sampling using the acquired logit.

10. A computer system comprising:
a memory; and
a processor configured to connect to the memory and to execute at least one instruction stored in the memory,
wherein the processor is configured to acquire a logit based on a beam search for a single utterance in a target domain, and to adjust parameters of the speech recognition model by performing entropy minimization and negative sampling using the acquired logit.
